(19) United States
(12) Patent Application Publication
(10) Pub. No.: US 2012/0186408 A1
(43) Pub. Date: Jul. 26, 2012

(54) Workpiece processing machine and method of operation thereof

(76) Inventor: Reinhard Vogt, Darmstadt (DE)

(21) Appl. No.: 13/353,539

(22) Filed: Jan. 19, 2012

(30) Foreign Application Priority Data
Jan. 24, 2011 (DE) 10 2011 009 299.4

(51) Int. Cl. B26D 7/22; F16P 3/14; B23Q 11/00

(52) U.S. Cl. 83/13; 83/58

(57) ABSTRACT

In a method of operating a cutting machine, a punching machine or the like, with a sensor, which operates in a danger zone of the machine, and with a control device, the control device interacts with the sensor in such a way that, in an active state of the sensor, the intrusion of an object into the danger zone is detected by the sensor and an appropriate object detection signal is transmitted by the sensor to the control device. After receiving the object detection signal, the control device triggers a safety measure, and to ensure that the safety measure is not triggered unnecessarily and to ensure the safety of the operating personnel, the sensor is switched by the control device into an inactive state before the start of a predetermined process step. The speed of danger-relevant machine parts is thereby limited to a predetermined maximum value.

### CROSS-REFERENCE TO RELATED APPLICATION

The invention described and claimed hereinbelow is also described in German Patent Application DE 10 2011 009 299.4-14 filed on Jan. 24, 2011. This German Patent Application, whose subject matter is incorporated here by reference, provides the basis for a claim of priority of invention under 35 U.S.C. 119(a)-(d).

### BACKGROUND OF THE INVENTION

The present invention relates to a workpiece processing machine and a method of operation of the workpiece processing machine.

More particularly, it relates to a workpiece processing machine, in particular a cutting machine, a punching machine or the like, which has a sensor, in particular a light barrier system, which operates in a danger zone of the machine, and comprising a control device, wherein the control device interacts with the sensor in such a way that, in an active state of the sensor, the intrusion of an object into the danger zone is detected by the sensor and an appropriate object detection signal is transmitted by the sensor to the control device, wherein, after receiving the object detection signal, the control device triggers a safety measure, e.g. a shutdown of the machine (emergency stop). The invention further relates to a corresponding workpiece processing machine comprising the sensor described above and the control device described above.

Document DE 10 2004 043 514 A1 has already made known such a method for operating a machine, in which a sensor disposed above a machine observes a monitored zone comprising the working zone of the machine, within which a robot arm moves, and comprising a zone adjacent thereto. In the known method, a danger zone within the monitored zone is defined, and a safety-relevant function must be triggered upon intrusion therein by an object. For example, the machine can be shut down if a person enters the danger zone. The size and shape of the danger zone is defined by an evaluation unit on the basis of the data obtained directly from the machine controller, such as the position, speed of motion and direction of motion of the robot arm. It is therefore possible to minimize the danger zone. The danger zone can be defined in a dynamic manner, i.e. such that it accompanies the robot arm, or in a static manner. Observing and defining a monitored zone in such a manner is extremely complex.

In the case of cutting machines, punching machines or similar workpiece processing machines, an unwanted trigger of the safety-relevant function can occur often in individual process states due, for instance, to flying sparks, cinder spray and other emissions, thereby greatly impairing the production process.

Document DE 20 2008 016 093 U1 describes a monitoring sensor which is provided to monitor a protected zone of a machine, wherein said monitoring sensor scans the at least two-dimensional protected field. To solve the above-described problem, various monitored fields are defined in the known system, for each of which a permitted dwell time of an object can be set using an evaluation unit. If the actually measured dwell time of an object exceeds the permitted dwell time for the associated monitored field, an appropriate detection signal is generated. Particles such as chips or spraying cooling fluid, which should not trigger the safety-relevant function, can be detected in a monitored field only very briefly, i.e. within the permitted dwell time. A related object detection signal is therefore not generated. Such a procedure can result in a marked reduction of the reaction speed of the system, however, in particular if the permitted dwell time in a monitored field is longer. Due to the observation of the dwell time of the intruding object and activation only when the permitted dwell time has been exceeded, the reaction time with respect to intrusion by objects, such as persons, which requires that the safety measure be triggered, also changes, of course. As a result, it is possible that the object will approach the danger zone, which is hazardous.

Document DE 44 24 537 A1 addresses this very problem. The light grating described in said document, which comprises a row of adjacently disposed light transmitters and light receivers, scans a protected field in a cyclic manner. As this occurs, certain defined interruptions of the protected field that are classified as non-hazardous, such as sparks traveling at a speed above a minimum speed, do not result in the triggering of an alarm or a shut-off signal. This procedure also requires a relatively complicated and elaborate device and signal processing.

### SUMMARY OF THE INVENTION

The problem addressed by the present invention is therefore that of providing a simple method of operating a workpiece processing machine, which does not result in a safety measure being triggered in the case of disturbances such as flying sparks or cinder spray.

A further problem to be addressed is that of creating a corresponding workpiece processing machine which is simple and can be created in a cost effective manner.

The above-described problem is solved by a method in which the sensor is switched into the inactive state by the control device before the start of the predetermined, critical process step of the machine and, simultaneously, the speed of danger-relevant machine parts is limited to a predetermined maximum value.

The above-described method according to the invention is based on the knowledge that the unwanted triggering of a safety measure is limited, with respect to time, to the duration of a critical process step or a plurality of critical process steps, i.e. to a few seconds of the entire process carried out by the machine. In such a critical process step it makes sense to deactivate the sensor, i.e. to switch it into an inactive state. In the inactive state, the sensor does not detect objects that may have entered the danger zone, nor does it generate an object detection signal in this state. Alternatively, in the inactive state of the sensor, an object detection signal transmitted by the sensor is ignored by the control device. In the active state, however, the sensor detects objects that have entered the danger zone, generates an object detection signal and transmits it to the control device which takes it into account. This is required in particular to protect the machine operator from the dangers of the machine.

The sensor is preferably in the form of a light barrier or another optical sensor. In a preferred embodiment, the sensor is disposed such that it accompanies the machine, e.g. at a portal. The light barrier contains, in a known manner, a light transmitter and a light receiver, wherein a light beam, such as a laser light beam, is transmitted by the light transmitter and is received by the light receiver. When an object enters the danger zone surrounded by the light barrier, the light beam is interrupted and the light receiver does not receive a signal. Intrusion by the object is thereby detected. To reduce the number of light transmitters, it is also possible to use beam splitters and beam spreading devices.

The speed of danger-relevant machine parts is reduced to a particular predetermined maximum value simultaneously with the deactivation of the sensor, in order to minimize the danger posed to persons or other objects that have entered the danger zone within this period of time.

The protective function of the sensor which triggers a safety measure when an object enters the danger zone is therefore not active during the predetermined, critical process step. However, since the speed of the danger-relevant machine parts is limited to a low, safe speed permitted without a safety device for the duration of the critical process, the protective function is also not absolutely necessary in this period of time. Since the critical process step(s) each involve only a short period of time, reducing the speed of the danger-relevant machine parts does not substantially extend the production process, and therefore negative effects on the productivity of the process are not expected.

The measure indicated is a very simple, easily achieved measure which can be attained cost effectively and requires no additional hardware.

To ensure maximum safety, according to a preferred embodiment, the sensor is switched back into the active state by the control device at the end of the predetermined process step of the machine. In the embodiment, the limitation of the speed of the danger-relevant machine parts is also lifted at the same point in time.

During the course of operation of the workpiece processing machine, the case can arise in which the end of the critical process step is not detected by the control device, or is detected too late. For this case it is advantageous for the switching back of the sensor into the active state by the control device to take place independently of the occurrence and/or the detection of the end of the predetermined process step at the latest after expiration of a predefined time period after deactivation of the sensor. By way of this time-based limitation of the inactive state of the sensor, it is ensured that the safety of persons or other objects is protected again after a short time, such as after 5 seconds.

To prevent an unnecessary extension of the production time of the workpiece processing machine, according to one embodiment of the present invention, the reactivation of the sensor is simultaneously accompanied by the lifting of the limitation of the speed of the danger-relevant machine parts.

Even if the speed of the danger-relevant machine parts is limited in the inactive state of the sensor, it cannot be ruled out that individual machine parts will exceed the particular predefined maximum value of the speed for any particular reason. This could definitely be dangerous to persons and other objects. Therefore, in one embodiment of the present invention, the speed of these machine parts is monitored during the inactive state of the sensor and, if the particular maximum value is exceeded, a safety measure is triggered. Such a safety measure can be, for example, stoppage of the workpiece processing machine (emergency stop), wherein all potentially hazardous elements of the machine are preferably shut off, such as the machine drive or the energy supply for workpiece processing. The safety measure utilized when the speed is exceeded can be identical to or differ from the safety measure that is implemented in response to intrusion by an object.

The problem described above is also solved by a workpiece processing machine, in which case the sensor can be switched into an inactive state by the control device before the start of a predetermined process step of the machine and, simultaneously, the speed of danger-relevant machine parts can be limited by the control device to a predefined maximum value. The advantages of such a workpiece processing machine and the further embodiments correspond to those of the above-described method according to the invention.

With respect to the workpiece processing machine, it is advantageous in particular for the control device to be in the form of two parts and to comprise a functional control part and a safety control part. The functional control part monitors the process steps of the machine, and the safety control part monitors the sensor operating in the danger zone. The start of the critical, predetermined process step is therefore known to the functional control part. The functional control part transmits a deactivation signal to the safety control part before the start of the predetermined process step: After receiving the deactivation signal, the safety control part deactivates the sensor and limits the danger-relevant machine parts with respect to the speed thereof.

Further objectives, features, advantages and potential applications of the present invention will also become apparent from the following description of an embodiment of the workpiece processing machine according to the invention and of the method for the operation thereof according to the invention, with reference to the figures. All of the features that are described and/or graphically depicted are the subject of the present invention, either alone or in any combination, independently of their wording in the claims or their dependency references.

### BRIEF DESCRIPTION OF THE DRAWINGS

FIG. 1 is a view showing the layout of a workpiece processing machine according to the invention,

FIG. 2 is a view showing a first flow chart of the method according to the invention, in a critical process step, and

FIG. 3 is a view showing a second flow chart of the method according to the invention, in a further critical process step.

### DESCRIPTION OF THE PREFERRED EMBODIMENTS

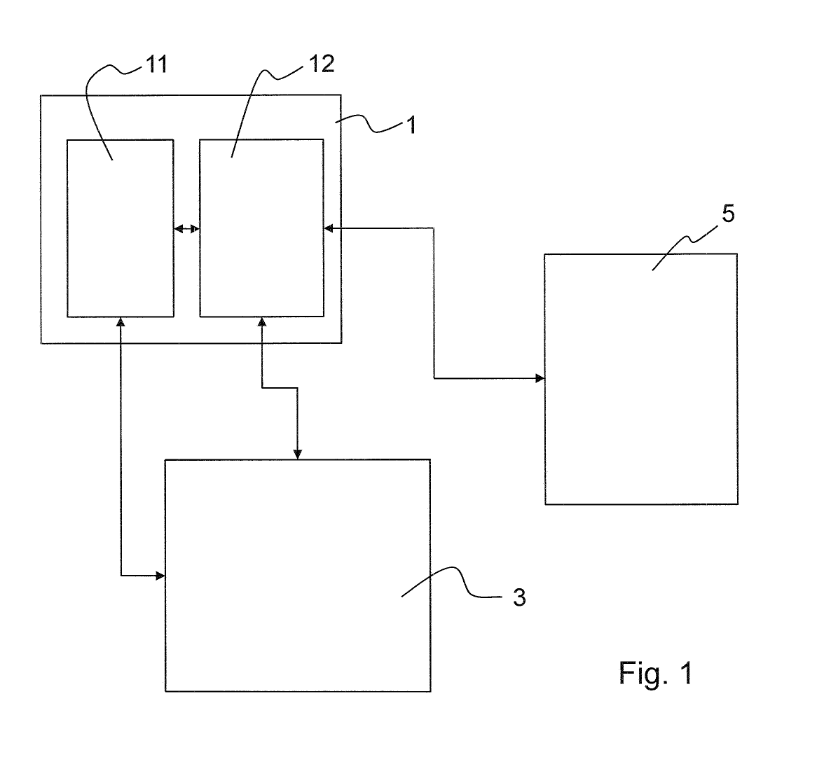

The invention is described in the following with reference to a cutting machine as the workpiece processing machine, and is depicted in FIG. 1. The present invention is not limited to a cutting machine, however, but rather can also be used for other workpiece processing machines such as punching machines, sawing machines or the like.

The control device 1 of the cutting machine comprises a functional control part 11 and a safety control part 12, which can exchange data with one another by way of a bidirectional connection. All double arrows shown in FIG. 1 basically represent bidirectional connections for data exchange.

The task of the functional control part 11 is to run application programs, i.e. to control the cutting process and, therefore, control the motion of the cutting tool along the cutting geometry. To this end, the functional control part 11 is connected to the machine drive 3 of the machine, which moves the cutting tool, for example. The functional control part 11 of the control device 1 has information, in particular, as to which process state the cutting machine is in.

The safety control part 12 controls and monitors safety sensors, such as the emergency off switch, the zone end switch, the collision protection devices, and one or more light barriers 5 which monitor the danger zone of the cutting machine. Each light barrier 5 is disposed at a boundary of the two- or three-dimensional danger zone of the cutting machine, thereby ensuring that the particular light barrier 5 detects intrusion by an object, such as a person, a manipulation tool or other machine or robot parts, by way of an interruption of the light signal.

Each light barrier 5 can assume an active state and an inactive state. In the active state, the light barrier 5 responds to an interruption of the light beam and thereby detects an intrusion of an object into the danger zone. In the inactive state, the light barrier 5 does not detect such an intrusion by an object and is preferably shut off. Alternatively, in the inactive state, an object detection signal transmitted to the safety control part 12 is ignored in the safety control part 12.

If an object enters the danger zone when the light barrier is in the active state, an appropriate object detection signal is generated by the light barrier 5 and is transmitted to the safety control part 12. The safety control part 12 then triggers a safety measure. For example, the safety measure can be a machine stoppage, in which the safety control part 12 transmits a stop signal to the machine drive 3 of the machine. As a further safety measure, alternatively or in addition thereto, the energy required to process the workpiece, i.e. to cut the workpiece in this case, is shut off. The safety control part 12 has the task of adhering to the safety concept of the cutting machine even if the functional control part 11 should fail. To this end, the safety control part comprises components which are certified and approved for safety applications.

So-called hole punching, which precedes the actual cutting of the workpiece, is a critical process step in which flying sparks and/or cinder sprays can interfere with the light barrier. According to the invention, the light barrier 5 is switched into the inactive state during hole punching, and the speed of the danger-relevant machine parts, such as that of the cutting tool, is limited.

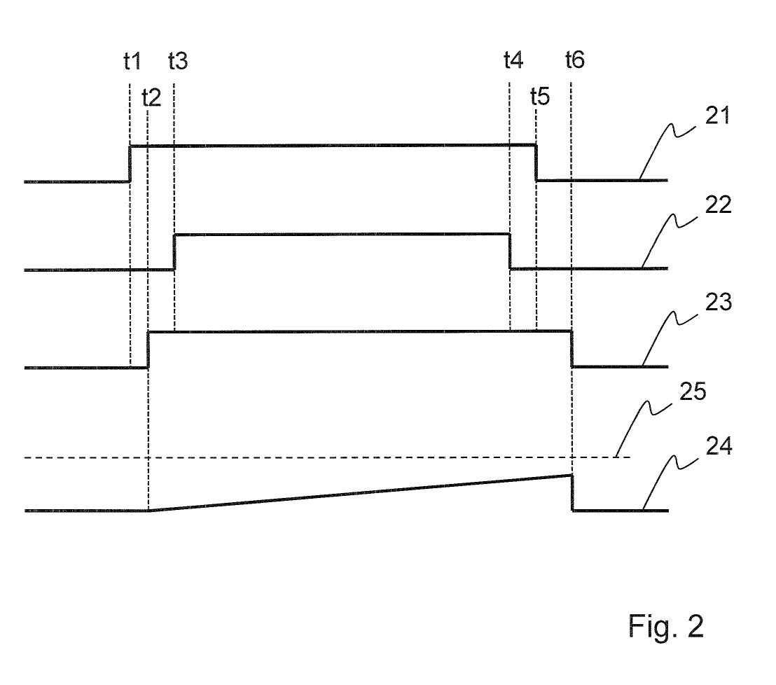

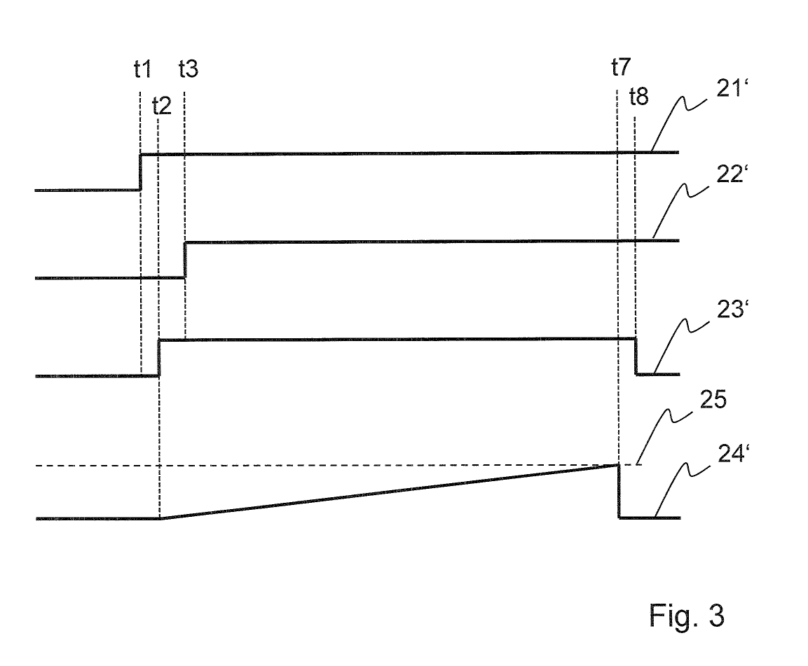

The method carried out by the cutting machine is explained in the following with reference to the flow diagrams presented in FIGS. 2 and 3. Signals graphs are plotted as a function of time in the flow diagrams.

The signal labelled with reference character 21 represents the reporting of the critical process step “hole punching” by the functional control part 11. Immediately before this process step begins, the signal level jumps from low to high (or from 0 to 1) at time t1. The signal is transmitted to the safety control part 12 which then deactivates the light barrier 5 at time t2 (see signal 23). Furthermore, starting at time t2, the machine drive 3 is controlled by the functional control part 11 in such a way that the danger-relevant parts of the machine, in particular the cutting tool, are moved only at a particular predefined maximum speed, thereby ensuring that persons and objects are not placed in danger even when the light barrier 5 is shut off. Furthermore, speed monitoring which is integrated in the machine drive 3 is activated at time t2, thereby monitoring the speed of the danger-relevant machine parts, e.g. of the cutting tool, in such a way that the actual speed does not exceed the particular maximum value. An appropriate signal is transmitted to the machine drive 3 for this purpose. At time t3, the hole punching can actually be started by the functional control part 11 by way of an appropriate signal to the machine drive 3 (see signal 22).

Upon completion of the hole punching, which is detected by the functional control part 11 by way of the change of the signal 22 at time t4, the reporting signal 21 of the critical process step is also varied accordingly at time t5. Furthermore, the process state is transmitted to the safety control part 12, and therefore the light barrier 5 is switched back into the active state at time t6, and the speed limitation of the danger-relevant machine parts is deactivated by the machine drive 3. Furthermore, the speed monitoring of these machine parts is also deactivated at this point in time.

To ensure that the machine is operated safely regardless of whether the functional control part 11 detects the end of the critical process step and transmits an appropriate signal to the safety control part 12, a clock is started at time t2 when the light barrier is deactivated, which measures the time that has passed since the light barrier was deactivated. This time measurement is shown in FIGS. 2 and 3 by way of the signal 24 and 24′, in which the signal level is a measure of the time that has passed since time t2 when the light barrier 5 was deactivated. When the signal level reaches a certain predefined level shown as line 25 in FIGS. 2 and 3, a time limit has been reached at which the light barrier 5 is reactivated independently of the conclusion of the hole punching or transmission of related signals. In the behavior of the cutting machine depicted in FIG. 2, the signal 24 does not reach the line 25 and, therefore, does not reach the time limit.

If, in the inactive state of the light barrier 5, the speed monitoring detects that the predefined maximum speed of the danger-relevant machine parts has been exceeded, a safety measure such as machine stoppage is implemented. It is transmitted by the safety control part 12 to the machine drive 3 of the machine.

In contrast, the signal 24′ of the variant course depicted in FIG. 3, which matches the course shown in FIG. 2 in the events at times t1 to t3, reaches the level 25 and, therefore, the predetermined time limit at time t7. By way of the signals 21′ and 22′ it is shown that conclusion of the hole punching had not been detected up to that point by the functional control part 11. In this case, when the time limit is reached, the safety control part 12 reactivates the light barrier 5 at time t8 and terminates the speed monitoring and speed limitation of the danger-relevant machine parts.

The method according to the invention and the workpiece processing machine according to the invention make it possible to ensure safe operation of the machine using simple means in a critical process step such as hole punching. Although the light barrier 5 is in the inactive state in the critical process step, this method is safe since the machine travels at a safe maximum speed during this time.

If the functional control part 11 does not detect the start of the critical process step, the light barrier 5 is not deactivated, thereby ensuring that the machine can be operated safely even in this case. In this case the light barrier 5 continues to operate and interacts with the safety control part 12. The light barrier can then be interrupted, at most, in an unwanted manner by flying sparks or cinder spray.

It will be understood that each of the elements described above, or two or more together, may also find a useful application in other types of methods and constructions differing from the types described above.

While the invention has been illustrated and described as embodied in a workpiece processing machine and method for operation thereof, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A method of operating a workpiece processing machine having a sensor and a control device, comprising the steps of operating the sensor in a danger zone of the machine; interacting the control device with the sensor in such a way that in an active state of the sensor an intrusion of an object into the danger zone is detected by the sensor and an object detection signal is transmitted by the sensor to the control device; after receiving the object detection signal, triggering by the control device a safety measure; and switching the sensor into the inactive state by the control device before a start of a predetermined critical process step of the machine and, simultaneously, limiting a speed of danger-relevant machine parts to a predetermined maximum value.

2. A method as defined in claim 1, further comprising operating the work processing machine selected from the group consisting of a cutting machine and a punching machine.

3. A method as defined in claim 1, further comprising switching the sensor back into the active state by the control device at an end of a predetermined process step of the machine.

4. A method as defined in claim 3, further comprising always returning the sensor by the control device to the active state at the latest after expiration of a pre-determined time period after deactivation of the sensor.

5. A method as defined in claim 4, further comprising accompanying a reactivation of the sensor simultaneously by removal of the limitation of the speed of the danger-relevant machine parts,

6. A method as defined in claim 1, further comprising monitoring the speed of the danger-relevant machine parts in the active state, and, if a particular maximum value is exceeded, triggering the safety measure.

7. A method as defined in claim 1, further comprising using a light barrier system as the sensor.

8. A work-piece processing machine, comprising a sensor operating in a danger zone of the machine; and a control device interacting with such sensor in such a way that in an active state of said sensor an intrusion of an object into the danger zone is detectable by said sensor and an object detection signal is transmitted by said sensor to said control device, and after receiving the detection signal said control device triggers a safety measure, wherein said sensor is switchable into an inactive state by said control device before a start of a pre-determined process step of the machine, and simultaneously, a speed of danger-relevant machine parts is limited by said control device to a pre-determined maximum value.

9. A work-piece processing machine as defined in claim 8, wherein the work-piece processing machine is a machine selected from the group consisting of a cutting machine and a punching machine.

10. A work-piece processing machine as defined in claim 8, wherein said sensor is switchable back into the active state by said control device at an end of a pre-determined process step of the machine.

11. A work-piece processing machine as defined in claim 10, wherein said control device always returns said sensor to the active state at the latest after expiration of a pre-determined time period after a deactivation of said sensor.

12. A work-piece processing machine as defined in claim 10, wherein said control device removes the limitation of the speed of the danger-relevant machine parts simultaneously with a reactivation of said sensor.

13. A work-piece processing machine as defined in claim 8, wherein said control device, in an inactive state of said sensor, monitors the speed of the danger-relevant machine parts, and triggers the safety measure if a particular maximum value is exceeded.

14. A work-piece processing machine as defined in claim 8, wherein said control device has a functional control part and a safety control part, wherein said functional control part monitors process steps of the machine and said safety control part monitors said sensor operating in the danger zone, wherein said functional control part transmits the deactivation signal to said safety control part before the start of the pre-determined process step, after a receipt of which signal by said safety control part said sensor is deactivated and the speed of the danger-relevant machine parts is limited.

15. A work-piece processing machine as defined in claim 8, wherein said sensor is a light barrier system.
